(19) United States
(12) Patent Application Publication
(10) Pub. No.: US 2012/0226798 A1
(43) Pub. Date: Sep. 6, 2012

(54) FAST NETWORK DISCOVERY USING SNMP MULTI-CAST

(75) Inventor: Nishant Krishna, Gaya (IN)

(73) Assignee: AVAYA INC., Basking Ridge, NJ (US)

(21) Appl. No.: 13/038,989

(22) Filed: Mar. 2, 2011

(51) Int. Cl. G06F 15/16

(52) U.S. Cl. 709/224

(57) ABSTRACT

A network management device sends an SNMP multi-cast GET on a network to discover all the network devices on the network or subnet. The network management device builds a Management Information Base (MIB) based on the responses received from the SNMP multi-cast GET. The MIB information is then sent to a Network Management System (NMS).

The SNMP multi-cast GET can be sent based on a command to discover network devices on the network or can be sent based on a polling algorithm. The system and method also include the ability to send an SNMP multi-cast SET to set the same parameter(s) on all the devices on the network/subnet.

### TECHNICAL FIELD

The system and method relates to Simple Network Management Protocol (SNMP) systems and in particular to SNMP systems that use multi-cast.

### BACKGROUND

Currently, Network Management Systems (NMS) that use Simple Network Management Protocol (SNMP) send individual SNMP GET commands to all addresses on a network as a process for discovering devices on the network. If a device resides at the address, the device responds to the SNMP GET so the NMS will know that there is a device at the address. If a device does not reside at an address on the network, the NMS will time-out and assume that there is not a device currently at the address. Through this process, the NMS can determine where devices are on the network.

The problem with this type of process is that for a large network the number of packets sent by the NMS to discover all the devices on the network may be very time consuming and will require the NMS to send a large amount of packets. For example, if the network is an Internet Protocol (IP) class B network, the NMS would have to send out over 65,000 SNMP GETs to determine if there are devices at each address on the network. If only half the IP addresses are used, the NMS will send over 32,000 messages that are not even answered. This process tends to be very inefficient for large networks and creates a lot of unnecessary traffic on the network.

This problem only gets exacerbated when there is a firewall between the NMS and the network. Some firewalls are configured to either not allow traffic on a specific IP port or to limit traffic on a specific IP port. In these cases, the NMS may not be able to discover all the devices on the network due to the restrictions of the firewall.

### SUMMARY

The system and method are directed to solving these and other problems and disadvantages of the prior art. A network management device sends an SNMP multi-cast GET on a network to discover all the network devices on the network or subnet. The network management device builds a Management Information Base (MIB) based on the responses received from the SNMP multi-cast GET. The MIB information is then sent to a Network Management System (NMS).

The SNMP multi-cast GET can be sent based on a command to discover network devices on the network or can be sent based on a polling algorithm. The system and method also include the ability to send an SNMP multi-cast SET to set the same parameter(s) on all the devices on the network/subnet.

### BRIEF DESCRIPTION OF THE DRAWINGS

In order to describe the manner in which other advantages and features of the disclosure can be obtained, a more particular description of the principles briefly described below will be rendered by reference to specific embodiments thereof which are illustrated in the appended drawings. Understanding that these drawings depict only exemplary embodiments of the disclosure and are not therefore to be considered to limit its scope, the principles herein are described and explained with additional specificity and detail through the use of the accompanying drawings in which:

FIG. 1 is a block diagram of a first illustrative system for managing devices on a network using SNMP multi-cast.

FIG. 2 is a block diagram of a second illustrative system for managing devices on a network using SNMP multi-cast.

FIG. 3 is a flow diagram of a method for discovering devices using multi-cast SNMP GETs.

FIG. 4 is a flow diagram of a method for sending multi-cast SNMP SETs.

FIG. 5 is a flow diagram of a method for a network device to respond to SNMP messages.

### DETAILED DESCRIPTION

The following description and associated Figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

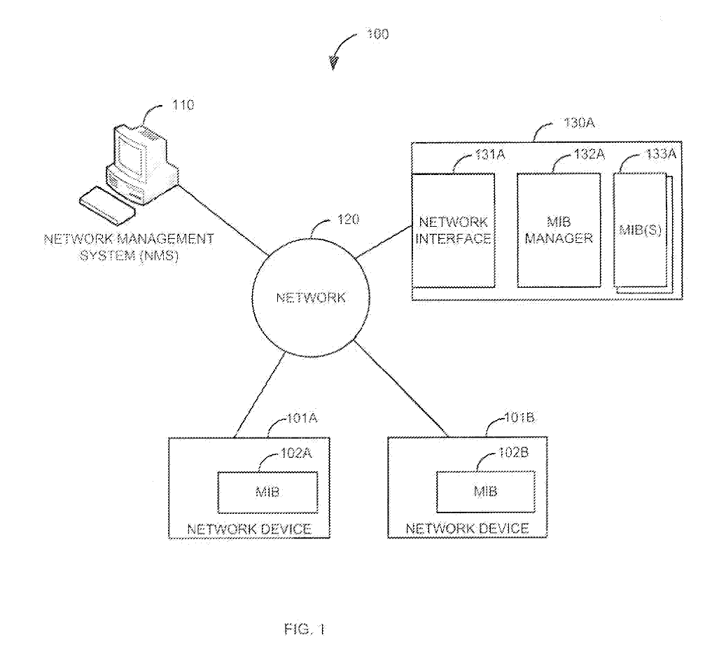

FIG. 1 is a block diagram of a first illustrative system 100 for managing network devices 101 on network 120 using SNMP multi-cast. First illustrative system 100 comprises Network Management System (NMS) 110, network 120, network devices 101A and 101B, and network management device 130A. Network management system 110 can be any device that can manage a network, such as a personal computer, a laptop computer, a server, a notepad, a Personal Digital Assistant (PDA), and the like. Network management system 120 can use a variety of protocols to manage network 120, such as Simple Network Management Protocol (SNMP) and the like. Network 120 can be any type of network, such as the Internet, a corporate network, an Internet Protocol (IP) network, a Local Area Network (LAN), a Wide Area Network (WAN), the Public Switched Telephone Network, a wireless network, a wired network, any combination of these, and the like. Network 120 can use one or more underlying protocols, such as Internet Protocol (IP), Integrated Digital Services Network (ISDN), Synchronous Optical Networking (SONET), Asynchronous Transfer Mode (ATM), a combination of these, and the like.

Network device 101 can be any type of device that can be managed on network 120, such as a server, a router, a hub, a printer, a firewall, a personal computer, a telephone, a wireless access point, and the like. FIG. 1 shows two network devices, 101A and 101B, for illustrative purposes. However, there can be additional network devices 101 (not shown) on network 120. Network device 101 further comprises an SNMP Management Information Base (MIB) 102. SNMP MIB 102 comprises information about network device 101 such as statistics on network device 101, settable parameters, configuration for SNMP traps, and the like. SNMP MIB 102 can be stored in a memory using a database, a file system, a directory service, and the like. The memory can be any type of memory that can store information, such as a Flash memory, a hard disk, a Random Access Memory (RAM), and the like. SNMP MIB 102 is shown as a single SNMP MIB 102, but SNMP MIB 102 can comprise multiple SNMP MIBs 102. Network device 101 also comprises some type of network interface (not shown) to gain access to network 120.

Network management device 130A can be any type of device that resides on a network, such as a server, a router, a hub, a printer, a firewall, a personal computer, a telephone, a wireless access point, and the like. In a typical example, network management device 130A will be a router. Network management device 130A further comprises network interface 131A, MIB Manager 132A, and MIB database 133A. Network interface 131A can be any type of device that can access network 120, such as an Ethernet interface, a wireless interface, a fiber optic interface, a modem, an Integrated Digital Services Network (ISDN) interface, a Digital Subscriber Line (DSL) interface, and the like. MIB manager 132A can be software/hardware that can manage MIB database 133A. MIB database 133A can be any type of MIB database, such as an SNMP MIB 102 or some other type of MIB record storage. MIB database 133A can be stored in a memory using a database, a file system, a directory service, and the like. The memory can be any type of memory that can store information, such as a Flash memory, a hard disk, a Random Access Memory (RAM), and the like.

Network management system 110 sends a command to network management device 130 to discover network devices 101 on network 120. Network interface 131A receives the command to discover network devices 101 on network 120. In one embodiment, network interface 131A responds to receiving the command to discover network devices 101 on the network 120 and sends a Simple Network Management Protocol (SNMP) multi-cast GET on network 120. Multi-cast is the sending of a message to a group of addresses. For example, a multi-cast message can go to a subnet (i.e., a portion of a class of an IP network) or a multi-cast can be a broadcast to a full IP network (i.e., all the addresses of a class IP network).

In this example, the SNMP multi-cast GET is a broadcast to all devices on network 120. Since the multi-cast GET is addressed to all network devices 101 on network 120, both network devices (101A and 101B) respond by sending a response to the SNMP multi-cast GET. The response to the SNMP multi-cast GET contains the address (i.e., in the IP address) of the particular network device (101A or 101B) and some or all of the information in SNMP MIB 102 of the particular network device (101A or 101B). In this example, network interface 131A receives the responses to the SNMP multi-cast GET from network devices 101A and 101B. Based on the response, MIB Manager 132A builds or updates MIB database 133A.

How MIB Manager 132A builds or updates MIB database 133A depends on if a response from a particular network device has been received. For example, assume that it is the first time that the SNMP multi-cast GET has been sent out on network 120 and that MIB database 133A is empty. The responses received from network devices 101A and 101B are used to build MIB database 133A. One way to build MIB database 133A is to have an instance for each network device 101 on network 120. Another way to do this would be to merge the information from network devices 101A and 101B in MIB database 133A. Typically, network devices 101 will send all of the contents of SNMP MIB 102 to network management device 130A. MIB Manager 132A then replicates the sent MIB information in MIB database 133A.

Later, network management device 130A can send additional SNMP multi-cast GET(s); based on the response to the additional SNMP multi-cast GET(s), MIB Manager 132A updates MIB database 133A with any changes. The additional SNMP multi-cast GET(s) can be sent based on receiving second command to discover network devices 101 on network 120 or based on some type of polling algorithm. Network management device 130A may then respond to the command to discover network devices by sending some or all of the contents of MIB database 133A to Network Management System 110.

Other alternatives of the above-described processes can also be implemented. For example, network management device 130A can periodically send out an SNMP multi-cast GET to update MIB database 133A. Based on the changes, network interface 131A can send at least a portion of MIB database 133A to network management system 110 (without receiving a request from network management system 110 to send MIB database 133A). The sending of MIB database 133A can be triggered based on an SNMP trap, based on changes to MIB database 133A, and the like.

The advantage of the above-described process is illustrated in the following example. Assume that network 120 is a class C IP network with 256 addresses. Using the prior art process, Network Management System 110 would have to send out 254 (or less depending upon the subnet mask) messages to discover devices on network 120. Using the above-described process, network management system 110 has to send a single message to network management device 130A; network management device 130A sends out a single SNMP multi-cast GET. This is a dramatic reduction in the number of messages and packets that must be sent and received.

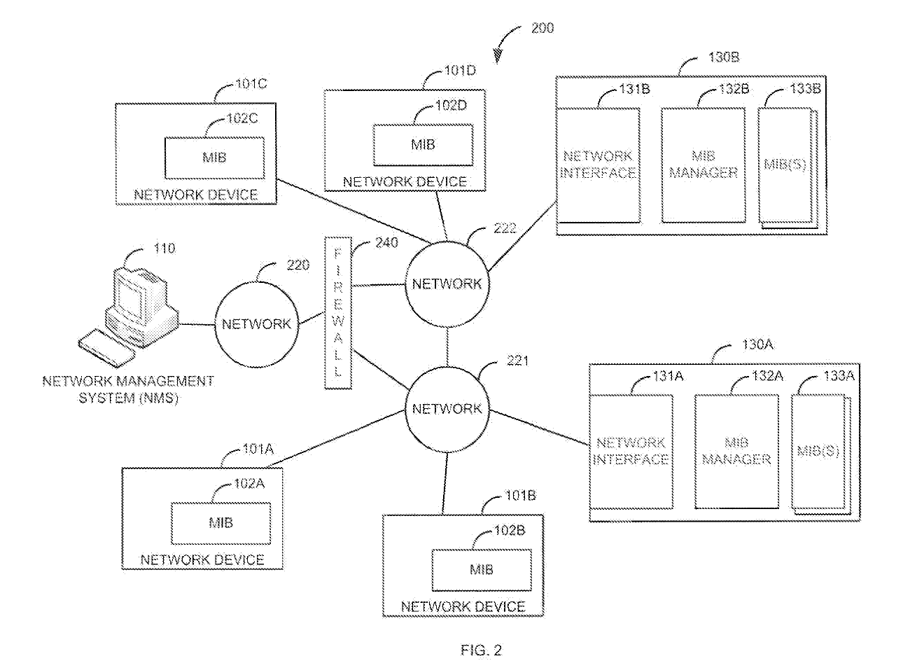

FIG. 2 is a block diagram of a second illustrative system 200 for managing devices 101 on networks (221 and 222) using SNMP multi-cast. Second illustrative system 200 comprises network devices 101A-D, network management system 110, networks 220, 221, and 222, network management devices 130A and 130B, and firewall 240.

Networks 220-222 can be any type of network, such as the Internet, an Internet Protocol (IP) network, a Local Area Network (LAN), a Wide Area Network (WAN), the Public Switched Telephone Network, a wireless network, a wired network, any combination of these, and the like. Networks 220-222 can use one or more protocols, such as Internet Protocol (IP), Integrated Digital Services Network (ISDN), Synchronous Optical Networking (SONET), Asynchronous Transfer Mode (ATM), a combination of these, and the like. In a typical example, network 220 is the Internet, and networks 221-222 comprise a corporate network. Networks 221-222 can comprise physical networks of a logical network (i.e., an IP network). Networks 221 and 222 can comprise separate IP networks.

Firewall 240 can be any device that can limit access between network 220 and networks 221-222. Firewall 240 can be implemented on a server, a router, a switch, a hub, a computer, a Private Branch Exchange (PBX), and the like.

Network management system 110 sends a command to discover network devices 101 on network 221 to network management device 130A. Network interface 131A receives the command to discover network devices 101 on network 221. Network interface 131A sends a Simple Network Management Protocol (SNMP) multi-cast GET on network 221.

In this example, the SNMP multi-cast GET is a broadcast to all devices on network 221. Network devices (101A and 101B) respond by sending a response to the SNMP multi-cast GET. The response to the SNMP multi-cast GET contains the address (i.e., in the IP address) of the particular network device (101A or 101B) and some or all of the information in SNMP MIB 102 of the particular network device (101A or 101B). Network interface 131A receives the responses to the SNMP multi-cast GET from network devices 101A and 101B. Based on the response, MIB Manager 132A builds or updates MIB database 133A.

The above process is repeated when network management system 110 sends a command to network management device 130B to discover network devices 101 on network 222. Network interface 131B receives the command to discover network devices 101 on network 222. Network interface 131A sends a Simple Network Management Protocol (SNMP) multi-cast GET on network 222.

In this example, the SNMP multi-cast GET is a broadcast to all devices on network 222. Network devices (101C and 101D) respond by sending a response to the SNMP multi-cast GET. The response to the SNMP multi-cast GET contains the address (i.e., in the IP address) of the particular network device (101C or 101D) and some or all of the information in SNMP MIB 102 of the particular network device (101C or 101D). In this example, network interface 131B receives the responses to the SNMP multi-cast GET from network devices 101C and 101D. Based on the response, MIB Manager 132B builds or updates MIB database 133B. Network management system 110 can then receive some or all of the data in MIB databases 133A and 133B by sending commands to get the information, or network management devices 130A and/or 130B can send the information in MIB databases 133A and/or 133B. Network management system 110 takes the information from MIB databases 133A and 133B to get a composite view of all the network devices 101A-101D on networks 221-222.

One key advantage to this type of system is that it dramatically reduces the amount of traffic that is sent through firewall 240. In this example, network management system 110 can discover all the devices on networks 221-222 by sending two commands and receiving two responses. This is an advantage over the prior art where network management system 110 would have to send a message to each address on network 221-222. Depending on how firewall 240 is configured, firewall 240 may not allow the sending of packets to each address on networks 221-222. Another advantage is that Network Management System 110 can send messages using a protocol with an allowed port number (i.e., HTTP) so that the Network Management System 110 can send and receive messages through firewall 240.

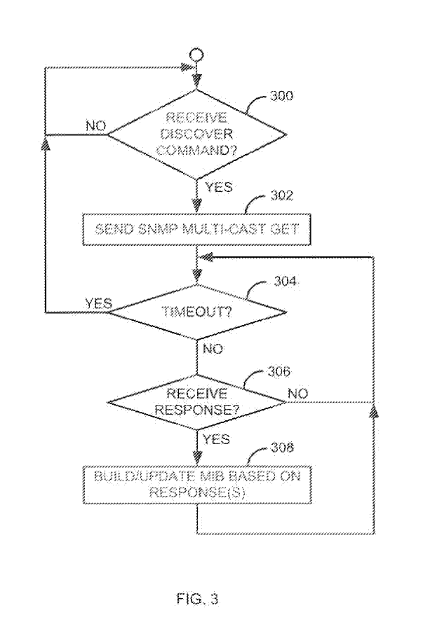

FIG. 3 is a flow diagram of a method for discovering devices using multi-cast SNMP GETs. Illustratively, network management system 110, network devices 101, network management device 130, and firewall 240 are stored-program-controlled entities, such as a computer or processor, which performs the method of FIGS. 3-5 and the processes described herein by executing program instructions stored in a tangible computer readable storage medium, such as a memory or disk.

The process begins in step 300 where network interface 131 waits to receive a discover command from network management system 110. Alternatively, network interface 131 can poll communication devices 101 periodically or based on some other type of algorithm. If network interface 131 does not receive a discover command, or it is not time to poll and send out an SNMP multi-cast get, the process repeats step 300.

Otherwise, if network interface 131 receives a discover command or determines it is time to poll by sending out an SNMP multi-cast GET, network interface 131 sends 302 an SNMP multi-cast GET on network 120. Network interface 131 determines in step 304 if a timeout has occurred. The timeout is used to gather the response(s) from network devices 101 on network 120. If a timeout has occurred in step 304, the process goes back to step 300. Otherwise, if a timeout has not occurred in step 304, network interface 131 determines in step 304 if it has received a response to the SNMP multi-cast GET that was sent in step 302. If a response has not been received in step 306, the process goes to step 304. Otherwise, if a response has been received in step 306, MIB Manager 132 updates/builds MIB database 133 based on the information received in the response to the SNMP multi-cast GET. The process then goes step 304.

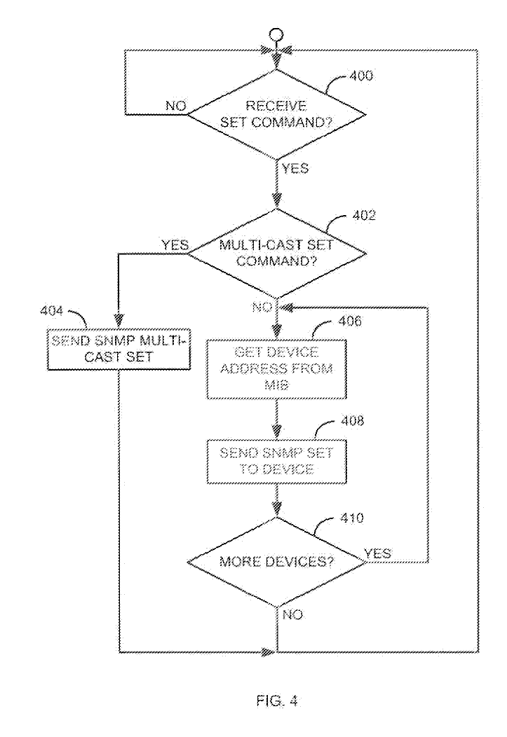

FIG. 4 is a flow diagram of a method for sending SNMP multi-cast SETs. The process begins in step 400 where network interface 131 waits to receive a set command from network management system 110. If network interface 131 has not received a set command in step 400, step 400 is repeated. Otherwise, if network interface 131 has received a set command in step 400, the process determines in step 402 if the set command was to send an SNMP multi-cast SET command. An SNMP multi-cast SET command will set the same parameter(s) in all the network devices 101 to which SNMP multi-cast SET is addressed to. If the set command is to send an SNMP multi-cast SET, (the command containing the value to set the parameter(s) to) network interface 131 sends 404 an SNMP multi-cast SET on network 120 and the process goes to step 400. Network interface 131 can also wait for an acknowledgment packet to the SNMP multi-cast SET (not shown), if necessary, before going to step 400.

If the command in step 402 is not a command to send an SNMP multi-cast SET, network interface 131 gets 406 the network device address (or some other information identifying the network device 101) from the command and the value to set the parameter(s) to. Network interface 131 sends 408 an SNMP SET to network device 101 using the address and value(s) to set the parameter(s). If there are more devices to send an SNMP SET to in step 410, the process goes to step 406. Otherwise, the process goes to step 400.

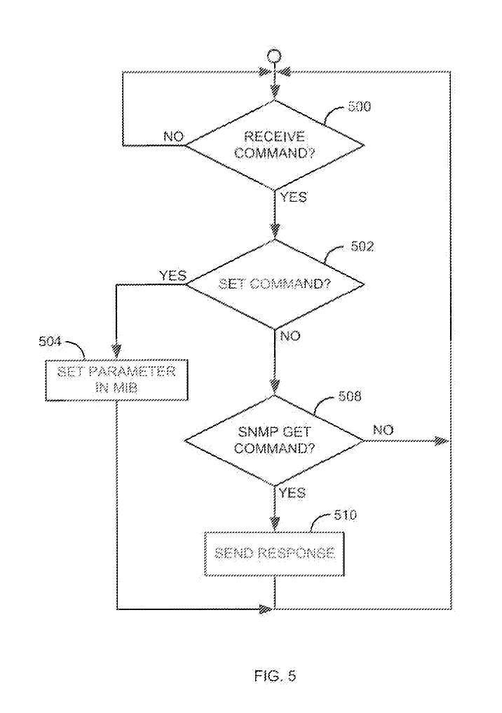

FIG. 5 is a flow diagram of a method for a network device 101 to respond to SNMP messages. Network device 101 waits in step 500 to receive an SNMP command. If a command is not received in step 500, the process repeats. If an SNMP command is received in step 500, network device 101 determines in step 502 if the command is an SNMP SET command (either a regular SNMP SET or an SNMP multi-cast SET). If the command is an SNMP SET command in step 502, network device 101 sets 504 the parameter(s) in SNMP MIB 102 and the process goes to step 500.

Otherwise, if the command is not an SNMP SET in step 502, network device 101 determines in step 506 if the command is an SNMP GET command. If the command is not an SNMP GET command in step 506, the process goes to step 500. Otherwise, if the command in step 506 is an SNMP GET command (either a regular SNMP GET command or an SNMP multi-cast GET command), network device 101 gets 508 the requested parameters and sends 510 a response to the SNMP GET. The process then goes to step 500.

Herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Herein, the term “a,” “an,” or another entity refers to one or more of that entity. As such, the terms “a” (or “an”), “one or more” and “at least one” can be used interchangeably herein. It is also to be noted that the terms “comprising,” “including,” and “having” can be used interchangeably.

Of course, various changes and modifications to the illustrative embodiment described above will be apparent to those skilled in the art. These changes and modifications can be made without departing from the spirit and the scope of the system and method and without diminishing its attendant advantages. The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
sending from a network interface a Simple Network Management Protocol (SNMP) multi-cast GET on a network;
receiving at the network interface one or more responses to the SNMP multi-cast GET, wherein the one or more responses to the SNMP multi-cast GET are associated with a different network device on the network; and
building or updating in a Management Information Base (MIB) manager, a MIB database based on the one or more responses to the SNMP multi-cast GET.

2. The method of claim 1, wherein the one or more responses are a plurality of responses, each from a plurality of different network devices, and wherein building the MIB database comprises building an instance for each of the plurality of different network devices in the MIB database.

3. The method of claim 2, further comprising the steps of receiving in the plurality of different network devices the SNMP multi-cast GET and in response to receiving the SNMP multi-cast GET, sending from the plurality of different network devices the plurality of responses.

4. The method of claim 2, further comprising receiving at the network interface a command to get the MIB database from a Network Management System (NMS) and responsive to receiving the command to get the MIB database, sending at least a portion of the MIB database.

5. The method of claim 4, further comprising the steps of sending from the Network Management System the command to discover the network devices on the network and the command to get the MIB database.

6. The method of claim 4, further comprising receiving a command at the network interface to set a parameter to a value in each of the plurality of different network devices and in response to receiving the command to set the parameter to the value, sending an SNMP multi-cast SET to the plurality of different network devices on the network.

7. The method of claim 4, further comprising receiving at the network interface a command to set a different parameter in each of the plurality of different network devices and in response to receiving the command to set the different parameter in each of the plurality of different network devices, sending a separate SNMP SET to each of the plurality of different network devices, wherein each separate SNMP SET sets a different parameter.

8. The method of claim 4, wherein the Network Management System sends a plurality of commands to get the MIB database to a plurality of network interfaces and receives a plurality of responses to the commands to get the MIB database.

9. The method of claim 1, further comprising the steps of receiving at the network interface a command to discover network devices on the network and responsive to receiving the command to discover network devices on the network, sending at least a portion of the MIB database to a network management system.

10. The method of claim 1, further comprising the step of sending by the network interface at least a portion of the MIB database to a network management system.

11. A system comprising:
a network interface operable to receive a command to send a Simple Network Management Protocol (SNMP) multi-cast GET on the network, receive one or more responses to the SNMP multi-cast GET, wherein the one or more responses to the SNMP multi-cast GET are associated with a different network device on the network; and
a Management Information Base (MIB) manager operable to build or update an MIB database based on the one or more responses to the SNMP multi-cast GET.

12. The system of claim 11, wherein the one or more responses are a plurality of responses, each from a plurality of different network devices, and wherein building the SNMP database comprises building an instance for each of the plurality of different network devices in the SNMP database.

13. The system of claim 12, wherein the plurality of different network devices are operable to receive the SNMP multi-cast GET and in response to receiving the SNMP multi-cast GET, send the plurality of responses.

14. The system of claim 12, wherein the network interface is further operable to receive a command to get the MIB database from a Network Management System (NMS).

15. The system of claim 14, wherein the Network Management System is further operable to send the command to discover the different network devices on the network and the command to get the MIB database.

16. The system of claim 14, wherein the network interface is further operable to receive a command to set a parameter to a value in each of the plurality of different network devices and in response to receiving the command to set the parameter to the value, sending an SNMP multi-cast SET to the plurality of different network devices on the network.

17. The system of claim 14, wherein the plurality of different network devices are operable to receive a command to set a different parameter in each of the plurality of different network devices and in response to receiving the command to set the different parameter in each of the plurality of different network devices, send a separate SNMP SET to each of the plurality of different network devices, wherein each separate SNMP SET sets a different parameter.

18. The system of claim 14, wherein the Network Management System sends a plurality of commands to get the MIB database to a plurality of network interfaces and receives a plurality of responses to the commands to get the MIB database.

19. The system of claim 11, wherein the network interface is operable to receive a command to discover network devices on the network and responsive to receiving the command to discover network devices on the network, sending at least a portion of the MIB database to a network management system.

20. The system of claim 11, wherein the network interface is operable to send at least a portion of the MIB database to a network management system.
